(19) United States
(12) Patent Application Publication
(10) Pub. No.: US 2024/0156135 A1
(43) Pub. Date: May 16, 2024

(54) METHOD FOR MANUFACTURING FROZEN NOODLES

(71) Applicant: NISSIN FOODS HOLDINGS CO., LTD., Osaka-shi, Osaka (JP)

(72) Inventors: Mai UTSUMI, Osaka-shi, Osaka (JP); Yusuke WADA, Osaka-shi, Osaka (JP); Takaharu YOKOISHI, Osaka-shi, Osaka (JP); Atsushi ONISHI, Osaka-shi, Osaka (JP); Toshio YOSHINUMA, Osaka-shi, Osaka (JP)

(21) Appl. No.: 18/552,278

(22) PCT Filed: Jun. 30, 2022
(86) PCT No.: PCT/JP2022/026130

§ 371 Date: Sep. 25, 2023

(30) Foreign Application Priority Data
Jul. 29, 2021 (JP) 2021-123945

(51) Int. Cl. A23L 7/109; A23L 3/36; A23L 7/113

(52) U.S. Cl. CPC A23L 7/111; A23L 3/36; A23L 7/113

(57) ABSTRACT

A method for manufacturing frozen noodles including a step of subjecting raw noodles or dried noodles manufactured by an ordinary method to boiling treatment to produce boiled noodles containing moisture less than moisture of the noodles after cooking, a step of applying water to surfaces of the boiled noodles by sprinkling or dipping, a step of filling a freezing container with the boiled noodles having water applied to the surfaces and an ice lump containing frozen water, and a step of subjecting the boiled noodles to freezing treatment, in which the freezing treatment is started within 120 seconds from an end of the boiling treatment.

### TECHNICAL FIELD

The present invention relates to a method for manufacturing frozen noodles.

### BACKGROUND ART

A technique for freezing freshly boiled noodles immediately has been disclosed until now (for example, Patent Literature 1 or 2). If freshly boiled noodles can be frozen immediately, this is preferable. When noodles are mechanically and continuously produced, very hot noodles are however continuously fed to a freezer in a large amount, and a great load is therefore applied to the freezer. There has been a problem that it takes not a little time to mechanically manufacture noodles from the end of the boil to the start of the freeze, and as time passes, the noodle strings become less disentangled, and the flavor and texture are deteriorated due to dryness of the surface of the noodle caused by evaporation or due to elution from the surfaces of the noodle strings.

Accordingly, as the method for manufacturing frozen noodles that are produced mechanically and continuously, the temperature of the boiled noodle has commonly been lowered by performing water wash cooling to reduce the burden on the freezer. In the case where water wash cooling is performed, however, components on the surfaces of noodles are washed away. Therefore, frozen noodles such as Chinese noodles and pasta not only decrease in rich flavor immediately after the boil of raw noodles, but the noodles are rapidly cooled into a firm state, and thus they have presented a different texture from texture immediately after raw noodles or dried noodles are boiled.

To solve these problems, the manufacturing method of Patent Literature 3 is disclosed. The manufacturing method of Patent Literature 3 is a method for manufacturing frozen noodles involving applying water to the surfaces of boiled noodles and then starting the freezing within 120 seconds without subjecting the boiled noodles to cold air cooling or water wash cooling. The method of Patent Literature 3 is an excellent method, but the method has had a problem that since the boiled noodles enter the freezer under a high temperature condition as compared with the cold air cooling or the water wash cooling, the production speed is reduced, or the production is stopped for removing frost to secure the capability of the freezer.

### CITATION LIST

### Patent Literature

Patent Literature 1: Japanese Patent Laid-Open No. 4-66066
Patent Literature 2: Japanese Patent Laid-Open No. 2012-16295
Patent Literature 3: Japanese Patent No. 6357175

### SUMMARY OF INVENTION

### Technical Problem

An object of the present invention is to reduce the burden of a freezer and improve the productivity in a method for manufacturing frozen noodles involving subjecting boiled noodles to freezing treatment soon after boiling while the qualities of the flavor and texture of noodles after the cooking are maintained.

### Solution to Problem

The inventors attempted to manufacture frozen noodles according to the invention described in Patent Literature 3, but they were confronted by the above-mentioned problem, and then have earnestly investigated a method for improving the productivity. As a result, the inventors have found a method for reducing the burden of a freezer and improving the productivity while the qualities of the flavor and texture of noodles after the cooking are maintained and completed the present invention.

More specifically, the present invention is a method for manufacturing frozen noodles, comprising: a step of subjecting raw noodles or dried noodles manufactured by an ordinary method to boiling treatment to produce boiled noodles containing less moisture than the moisture of noodles after cooking; a step of applying water to the surfaces of the boiled noodles by sprinkling or dipping; a step of filling a freezing container with the boiled noodles wherein the water is applied to the surfaces of the noodles and an ice lump containing frozen water; and a step of subjecting the boiled noodles to freezing treatment, wherein the freezing treatment is started within 120 seconds from the end of the boiling treatment.

The temperature of the boiled noodles according to the present invention when the freezing container is filled is preferably 30 to 60° C.

The weight of the ice lump according to the present invention is preferably 10 to 50% by weight of the total weight of the frozen noodles including the ice lump and the noodles.

The amount of water contained in the ice lump according to the present invention is preferably 5 to 40% by weight of the weight of the noodles after the cooking of the frozen noodles.

The frozen noodles according to the present invention are preferably Chinese noodles.

The frozen noodles according to the present invention are preferably for microwave oven cooking.

### Advantageous Effects of Invention

In a method for manufacturing frozen noodles involving subjecting boiled noodles to freezing treatment soon after the boiling, the present invention enables reducing the burden of a freezer and improving the productivity while maintaining the qualities of the flavor and texture of noodles after the cooking.

### BRIEF DESCRIPTION OF DRAWINGS

(a) to (d) of FIG. 1 is an explanatory drawing of a process from the end of boiling treatment to freezing treatment according to the present invention.

FIG. 2 is an explanatory drawing showing a method for measuring the temperature of boiled noodles before the freezing treatment according to experiments such as Examples of the present invention.

### DESCRIPTION OF EMBODIMENTS

Hereinafter, the present invention will be described in detail. The present invention is not, however, limited to the following description.

The type of frozen noodles to be manufactured in the present invention is not particularly limited, and may be any type commonly known in the art. Examples include Chinese noodles, wheat noodles (Udon), buckwheat noodles, and pasta.

1. Raw Material Formulation

Common raw materials of noodles can be used for frozen noodles according to the present invention. More specifically, as raw material powder, cereal flours such as wheat flour (including durum wheat flour), buckwheat flour, barley flour, and rice flour and various starches such as potato starch, tapioca starch, and cornstarch is used alone or as a mixture thereof. As the starch, modified starch such as raw starch, gelatinized starch, acetylated starch, etherified starch, and crosslinked starch can be used. Salt, an alkaline agent, various thickeners, a noodle quality modifier, edible fat or oil, various pigments such as a carotin pigment, and the like to be commonly used in the production of noodles can be added to these raw material powders. These may be added to the raw material powder as powder, or may be dissolved or suspended in kneading water for addition.

2. Noodle Making Step

The raw materials are kneaded to manufacture noodle dough (dough). More specifically, sub material powder such as a noodle quality modifier is added to the main raw material powder such as wheat flour or starch for power mixture, followed by further adding kneading water in which sub materials such as salt and an alkaline agent are dissolved in water, and the mixture was fully kneaded to manufacture dough so that the raw materials are homogenously mixed with a mixer. At this time, the mixing may be performed under reduced pressure with a vacuum mixer or the like.

Then, noodle strings are produced from dough manufactured in the kneading step. The production method only has to be performed according to an ordinary method. Examples include a method involving extruding the dough with an extruder or the like to produce noodle strings and a method involving compounding dough into a noodle belt, then rolling out the noodle belt by a roll multiple times to a predetermined noodle belt thickness, and cutting out the noodle belt with a cutting-out roll called a cutting blade or by cutting with a kitchen knife to produce noodle strings. At this time, the noodle belt may be produced with the extruder, then rolled out, and cut out. Multiple noodle belts may be combined into a noodle belt having a multilayer structure, followed by rolling out the noodle belt and cutting out the noodle belt. When the extruded noodle belt or the extruded noodle strings are produced with the extruder, the production is preferably performed under reduced pressure. Then, the produced noodle strings are cut to a suitable length into raw noodles.

In the present invention, not only raw noodles but also commercial dried noodles such as pasta, wheat noodles, buckwheat noodles, and Chinese noodles can be also used.

3. Boiling Treatment Step

Then, the produced raw noodles or dried noodles are filled into a bucket and subjected to boiling treatment to produce boiled noodles. Since the boiling temperature and the boiling time under preferable conditions vary depending on the type and the thickness of the noodles, preferable temperature only has to be appropriately set by adaptation to the target texture. The boiling temperature is preferably around 90 to 100° C.

With respect to the boiled noodles in the present invention, the boiling treatment of the noodles is stopped before the moisture content is an optimal moisture content for eating, and the moisture content is reduced by shortening the boiling time. The reduction of the moisture content not only enables easily reducing the temperature of the noodles in the water application step described below, lowering the temperature before the start of freezing, and suppressing steam coming off the boiled noodles, but also enables decreasing the weight of the boiled noodles to be frozen, resulting in reducing the load of a freezer. The shift of moisture in an amount by which the moisture of the boiled noodles is reduced to the ice lump described below enables transferring moisture from the ice lump to the noodle strings during cooking with a microwave oven or the like to adjust the moisture content to the optimal moisture content at the time of eating.

A preferable moisture content of the boiled noodles after the boiling treatment varies depending on the type of the noodles, and is preferably a moisture content that is 5 to 25% by weight lower than the moisture content (% by weight) of the noodles after cooking. For example, in the case of Chinese noodles, while the moisture content of the noodles at the time of eating is 60 to 70% by weight, the moisture content of the noodles after the boiling treatment is preferably 45 to 65% by weight. When the moisture content is too low, the gelatinization is insufficient. When the moisture content is too high, the effect of reducing the load of the freezer decreases.

4. Water Application Step

In general, the boiled noodles subjected to the boiling are water wash-cooled after the boiled noodles are subjected to liquid draining and before the boiled noodles are filled into the freezing container. If the noodles after the boiling treatment is not subjected to further treatment, the evaporation of moisture on the surfaces of the noodles binds the noodles to each other due to the dryness, and moisture in the noodles is rapidly homogenized, resulting in the softening of the texture. Then, rapidly cooling and tightening the noodles by water wash cooling not only enables suppressing the homogenization of moisture to prevent the texture from being deteriorated, but also enables removing slimness on the surfaces of the noodles to prevent the noodle strings from being bound to each other. However, since components on the surfaces of the noodles are lost by water wash cooling, the flavor is not only deteriorated, but rapidly tightening the noodles also hardens the texture on the surfaces. In the case of wheat noodles or the like, the texture of frozen noodles subjected to water wash cooling may be attractive. In the case of noodles like Chinese noodles wherein the surfaces are soft, and the cores feel elastic and tough, frozen noodles subjected to the water wash cooling is not, however, preferable in view of the flavor or texture.

In the present invention, water is applied to the surfaces of the noodles after the boiling by sprinkling the noodles with a shower or a spray or by dipping the noodles in the same way as Patent Literature 3. The water is applied mainly to prevent moisture evaporation from the surfaces of the noodles and to lower the temperature of the noodles for reducing the burden of the freezer less rapidly than in the water wash cooling to such an extent that the flavor of the noodles is not deteriorated.

Too large an amount of water sprinkled, long dipping time, or dipping of the noodles many times, however, allows components on the surfaces of the noodles to flow out. In the case of sprinkling with a shower or a spray, it is therefore preferable that the amount of water sprinkled be 30 to 500 mL with respect to 100 g of the boiled noodles. In the case of the dipping, and it is therefore preferable that the dipping be performed once, and the dipping time be on the order of 1 to 5 seconds. A more preferable amount of water sprinkled is 50 to 300 mL with respect to 100 g of the boiled noodles, and it is preferable that the dipping time be on the order of 1 to 2 seconds. The temperature of water to be used is not particularly limited. If the temperature of water is too high, the temperature of the boiled noodles hardly decreases, and it is therefore preferable that the temperature of water be ordinary temperature or less (at the highest 25° C.). At this time, it is preferable that the weight of water applied to the boiled noodles by sprinkling with a shower or a spray, or by immersion (weight by which the weight of the boiled noodles increase) be in the range of 5 to 30 g per 100 g of the boiled noodle after the boiling.

The temperature of the boiled noodles after the sprinkling or the immersion is preferably around 30 to 60° C.

If the temperature is too low, the water washing or the cooling progresses excessively, and the flavor or texture is deteriorated. If the temperature is too high, the temperature of the boiled noodles is not sufficiently lowered even with an ice lump as described later, steam comes off the noodles, and the burden of the freezer increases.

5. Ice Lump

In the present invention, an ice lump is filled together with the boiled noodles to which water is applied into a freezing container. As long as the ice lump according to the present invention is frozen, the ice lump is not particularly limited, and may be an ice lump in which only water is frozen, an ice lump frozen as a mixture of ingredients and water, or an ice lump in which sauce or soup is frozen. In the case of Chinese noodles, soup frozen into an ice lump stains the noodles with the color of the soup during storage and cooking, the frozen soup is not therefore preferable, and it is preferable to use an ice lump into which only water is frozen or an ice lump into which a mixture of water and ingredients such as roasted pork, Welsh onion, and pickled bamboo shoots is frozen. The shape of the ice lump is not particularly limited, and the ice lump only has to be produced so that the contact area between the ice lump and the noodles is as large as possible in adaptation to the shape of the freezing container. Examples include a method for producing the ice lump into a tabular shape as shown in (b) to (d) of FIG. 1 or into a cubic shape.

The weight of the ice lump is not particularly limited. If the weight is too heavy, the cooking time with a microwave oven or the like is lengthened. If the weight is too light, the effect of cooling the boiled noodle is reduced. The weight of the ice lump is preferably to 50% by weight of the whole weight of the frozen noodles including the noodles and the ice lump. If the weight is less than 10% by weight, it is difficult to cool the boiled noodles fully, and if the weight is more than 50% by weight, the cooking time for the microwave oven cooking or the like is lengthened. More preferably, the weight is 20 to 40% by weight.

In addition, in the present invention, the boiling time is shortened, and the moisture content of the boiled noodle is reduced, and therefore water is incorporated into the ice lump so that the moisture content is an optimal moisture content after the cooking. Preferable conditions vary depending on the type, the thickness, and the like of the noodles, and it is preferable to incorporate water at around 5 to 40% by weight of the noodles after the cooking into the ice lump. Moisture contained in the ice lump boils during the microwave oven cooking thereby. The noodles are heated while absorbing moisture. The conditions are similar to the conditions of the boiling cooking, and the flavor reduced by sprinkling or dipping is improved. The moisture content is an optimal moisture content for eating, and the texture is also improved.

6. Filling Step

As shown in (a) to (c) of FIG. 1, the ice lump 2 and the boiled noodles 3 described above are filled into a freezing container 1 in the present invention. The filling of the ice lump 2 on the boiled noodles 3 not only prevents chilliness from being transmitted to the boiled noodles 3 in the freezing treatment, but also flattens the boiled noodles 3 due to the weight of the ice lump 2. It is therefore preferable that the freezing container 1 be filled with the ice lump 2 and then filled with the boiled noodles 3.

As described above, filling the freezing container 1 with the ice lump 2 and the boiled noodle 3 together enables transmitting chilliness from the ice lump 2 to the boiled noodles 3 to lower the temperature of the noodles within a short period of time from the filling to the entrance of the noodles into the freezer. Even though time from the end of the boiling treatment to the freezing is short as compared with conventional methods such as the method of Patent Literature 3, the burden of the freezer can be reduced. In the present invention, since an appreciable amount of heat is removed in the moisture application step, even the contact of the ice lump 2 with the boiled noodles 3 does not tighten the noodles rapidly, and hardly influences the texture. Since the components are hardly eluted from the surfaces of the noodles as compared with in the case of the water wash cooling, the flavor is hardly influenced, and the food temperature of the boiled noodles can be lowered to reduce the burden of the freezer.

In addition, in the present invention, since the boiling time is shorted, the weight of the boiled noodles is less than that of normal frozen noodles, not only the load on freezing itself is reduced, but also the temperature of the noodles can be lowered with a smaller amount of water in the water application step than in normal frozen noodles. Furthermore, since the weight of the boiled noodles is less than that of normal frozen noodles, the temperature of the noodles can be lowered with the ice lump, and the load on the freezer can therefore be still further reduced. To reduce the burden of the freezer in the present invention, the temperature of the noodles before the noodles enter the freezer is preferably 55° C. or less and more preferably 50° C. or less.

7. Time from End of Boiling Treatment to Start of Freezing Treatment

In the present invention, the freezing treatment is started within 120 seconds from the end of the boiling treatment. If the time is longer than 120 seconds, the flavor is deteriorated over time, and it is not therefore preferable. The time is more preferably 100 seconds or less. Even though, in the mechanical production, time that it necessarily takes to perform steps such as the water application step or the filling step and the time from the end of boiling treatment to the start of the freezing treatment are too short, the effect of cooling the boiled noodles with the ice lump decreases, and the time is preferably 60 seconds or more.

8. Freezing Treatment Step

As the freezing treatment, the freezing container filled with the ice lump and the boiled noodles is then placed into the freezer and frozen. The freezing treatment in the present invention is not particularly limited, and it is preferable that the boiled noodles be rapidly frozen at a temperature of around −30 to −60° C. with an air blast spiral freezer, a tunnel freezer, a quick freezer, or the like. Since the boiled noodles before the freezing treatment according to the present invention decrease in the temperature or the weight of the noodles to be frozen as compared with conventional techniques, the burden of the freezer is reduced, and the frozen noodles can be produced without reducing the production speed or performing intermittent operation.

If the noodle lump frozen in the freezing step is formed together with the freezing container into an article for sale as it is, the frozen noodle lump frozen in the freezing treatment step may be wrapped in a packing material made of plastic as it is. After the plate removal from the freezing container, the frozen noodle lump can be wrapped in a packing material made of plastic and wrapped in an outer package with soup, oil, seasoning, and the like further attached separately as needed to be sold as frozen food (frozen noodles).

The frozen noodles manufactured by the present invention can also be cooked with hot water and the like in a pot and eaten, and is preferably cooked with a microwave oven and easily eaten. The boiling time is shortened to reduce the moisture content of the boiled noodles, and water is incorporated into the ice lump. Therefore, cooking the frozen noodles with a microwave oven boils moisture from the ice lump, heats the noodles while the noodles absorb the moisture, has an effect like boiling treatment, and improves the flavor and texture of the noodles.

While the qualities of the flavor or texture of the noodles after the cooking is maintained, the burden of the freezer can be reduced, and the productivity can be improved in the method for manufacturing frozen noodles mentioned above and involving subjecting raw noodles or dried noodles manufactured by an ordinary method to boiling treatment to produce boiled noodles containing less moisture than moisture of the noodles after cooking, then filling the boiled noodles with an ice lump containing water into a freezing container, and starting freezing treatment within 120 seconds form the end of the boiling treatment to subject the boiled noodles to the freezing treatment soon after boiling. Chinese noodles, having a strong flavor such as alkali smell peculiar to noodles, are particularly effective as the frozen noodles according to the present invention.

Hereinafter, the present embodiment will be described in further detail by giving Examples.

### EXAMPLES

### Example 1

To 1000 g of semi-strong flour were added 15 g of salt, 15 g of a kansui preparation (sodium carbonate:potassium carbonate:polyphosphate=50:45:5), and kneading water in which 1 g of gardenia pigment was dissolved in 360 g of water. The mixture was kneaded under normal pressure for 4 minutes and then kneaded under reduced pressure for 8 minutes with a vacuum mixer to produce doughs.

The produced doughs were compounded to produce a noodle belt, and the noodle belt was rolled out to 1.7 mm by rolling, the noodles belt was cut into noodle strings with a roll cutting blade of #20 square blade, and the noodle strings (moisture: 36% by weight) were cut to around 35 cm.

Then, 100 g of the cut noodle strings were placed into a bucket for boiling and subjected to boiling treatment in boiling water at 100° C. for 45 seconds. After the boiling, the hot water was drained for 20 seconds, water at ordinary temperature (20° C.) was sprinkled with a shower set at 100 mL/second for 1 second, and the noodle strings were subjected to liquid draining for 10 seconds.

Thirty seconds after the boiling, the boiled noodles to which water was applied were filled into a freezing container (upper diameter: 145 mm, lower diameter: 135 mm, height: 50 mm) beforehand charged with an ice lump produced with 14 g of roasted pork, 10 g of cut green onion, 7 g of pickled bamboo shoots, and 10 g of water placed into a mold (85×85 mm) and frozen. Air was lightly sprayed to level the noodles. Ninety seconds after the boiling, the noodles were placed into an air blast freezer at −35° C. and frozen for 30 minutes to produce a frozen Chinese noodle sample.

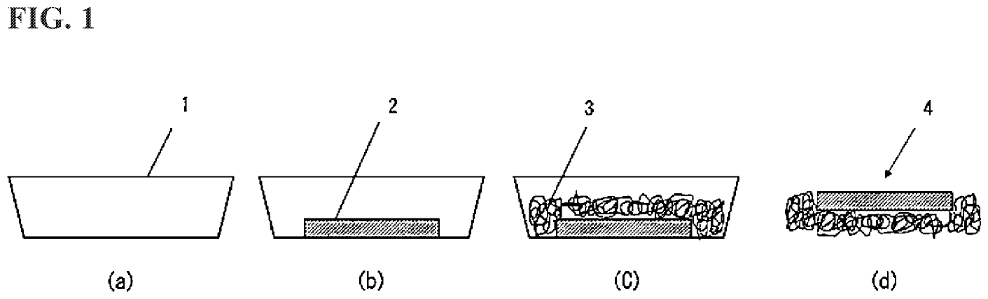

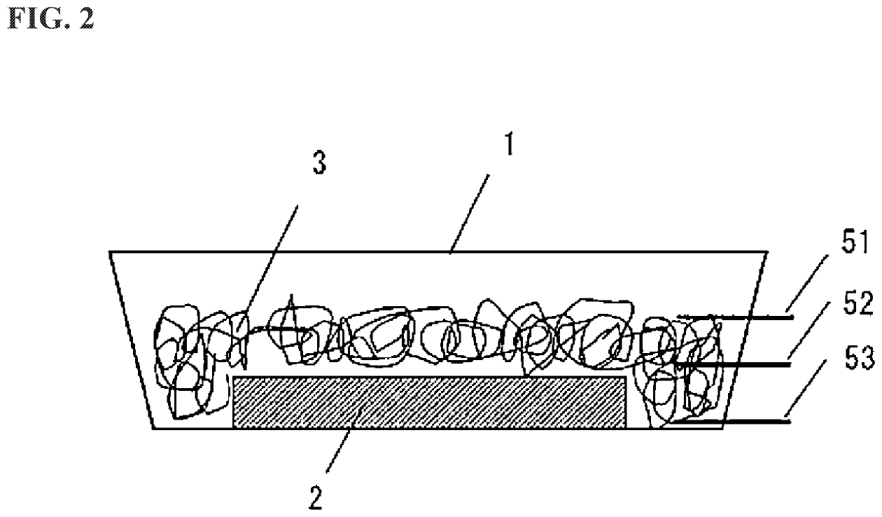

At this time, the moisture of the noodles after the boiling was measured. The temperature of the noodles immediately before the noodles were filled into the freezing container and the temperature of the noodles immediately before the noodles were placed into the freezer were measured. As shown in FIG. 2, the temperature of the noodles immediately before the noodles were placed into the freezer was measured with the needles of thermometers (51, 52, and 53) fixed on the front side of the noodles and at the center and the bottom of the noodles at a position 10 mm away from the ice lump at a position such that the distance between a freezing container 1 and an ice lump 2 was the longest when the ice lump 2 was set at the center of the freezing container 1. The temperature of the noodles with which an ice lump was not placed into a freezing container was measured with the needles fixed in the same way.

### Example 2

A frozen Chinese noodles sample was produced according to the method in Example 1 except that the boiling time was 30 seconds, and the weight of water in the ice lump was 45 g.

### Example 3

A frozen Chinese noodles sample was produced according to the method in Example 2 except that the noodles were dipped into water at normal temperature (20° C.) for 1 second instead of using the shower.

### Example 4

A frozen Chinese noodles sample was produced according to the method in Example 2 except that water was sprinkled with the shower for 7 seconds.

### Example 5

A frozen Chinese noodles sample was produced according to the method in Example 2 except that the time from the end of the boiling treatment to the start of the freezing treatment was 60 seconds.

### Example 6

A frozen Chinese noodle sample was produced according to the method in Example 2 except that the time from the end of the boiling to the start of the freezing treatment was 120 seconds.

### Comparative Example 1

A freezing Chinese noodle sample was produced according to the method in Example 1 except that the boiling treatment was performed for 50 seconds, after the end of the boiling treatment, the noodles were dipped together with the bucket into cold water at 15° C. for 30 seconds, subjected to liquid draining for 10 seconds, and then dipped into cold water at 10° C. for 30 seconds to subject the noodle strings to water wash cooling, and the noodles were drained for 20 seconds and filled into the freezing container not charged with the ice lump. The freezing treatment was started 150 seconds after the end of the boiling treatment.

### Comparative Example 2

A frozen Chinese noodles sample was produced according to the method in Example 1 except that the boiling treatment was performed for 50 seconds, and the ice lump was not filled.

### Comparative Example 3

A frozen Chinese noodles sample was produced according to the method in Comparative Example 2 except that the noodles were dipped into water at ordinary temperature (20° C.) for 1 second instead of using the shower.

### Comparative Example 4

A frozen Chinese noodle sample was produced according to the method in Comparative Example 2 except that the time for the shower was 7 seconds.

The produced frozen Chinese noodle samples were evaluated. The flavors of the noodles after cooking and the textures of the noodles after cooking were evaluated. The evaluation method was performed by five veteran panelists on the basis of 5 points. Each of the samples was cooked with a microwave oven at 500 W for 6 minutes. The noodles were placed into a vessel which had been charged with 400 ml of hot water provided beforehand together with a concentrated soy sauce-flavored liquid soup. The panelists ate the noodles and evaluated the flavor and texture of the noodles.

The flavor after the cooking evaluated as 5 was very good since the panelists very strongly felt the flavor of Chinese noodles as if the Chinese noodles had been freshly boiled. The flavor after the cooking evaluated as 4 was good since the panelists strongly felt the flavor of Chinese noodles as if the Chinese noodles had been freshly boiled. The flavor after the cooking evaluated as 3 was generally fair since the panelists felt the flavor of Chinese noodles as if the Chinese noodles had been freshly boiled. The flavor after the cooking evaluated as 2 was unacceptable since the flavor of Chinese noodles as if the Chinese noodles had been freshly boiled was weak. The flavor after the cooking evaluated as 1 was unacceptable since the panelist did not feel the flavor of Chinese noodles as if the Chinese noodles had been freshly boiled.

The texture after the cooking evaluated as 5 was very good since the texture was equivalent to the texture of freshly boiled Chinese noodles. The texture after the cooking evaluated as 4 was good since the texture was similar to the texture of freshly boiled raw noodles. The texture after the cooking evaluated as 3 was generally fair since the texture was slightly inferior to the texture of freshly boiled raw noodles. The texture after the cooking evaluated as 2 was unacceptable since the texture was inferior to the texture of freshly boiled raw noodles. The texture after the cooking evaluated as 1 was unacceptable since the texture was markedly inferior to the texture of freshly boiled noodles.

The weight and the moisture content of the noodles after the cooking were measured.

The following Table 1 shows the moisture after the boiling and the temperature change of each test area. The following Table 2 shows the results of the sensory evaluation and the weight and the moisture content of the noodles after the cooking.

TABLE 1

| | | | Water | From after | | Temperature | |
|---|---|---|---|---|---|---|---|
| | | Moisture | cooling and | boiling to | | immediately | Temperature |
| | Boiling | of boiled | water | start of | | after filling | before freezing |
| Test section | time | noodles | impartation | freezing | Ice lump | (average) | (average) |
| Example 1 | 45 | 62% | Shower 1 | 90 seconds | 41 g (water: | 59° C. | 52° C. |
| | seconds | | second | | 10 g) | | |
| Example 2 | 30 | 56% | Shower 1 | 90 seconds | 76 g (water: | 51° C. | 44° C. |
| | seconds | | second | | 45 g) | | |
| Example 3 | 30 | 56% | Dipping 1 | 90 seconds | 76 g (water: | 44° C. | 40° C. |
| | seconds | | second | | 45 g) | | |
| Example 4 | 30 | 56% | Shower 7 | 90 seconds | 76 g (water: | 30° C. | 27° C. |
| | seconds | | seconds | | 45 g) | | |
| Example 5 | 30 | 56% | Shower 1 | 60 seconds | 76 g (water: | 51° C. | 46° C. |
| | seconds | | second | | 45 g) | | |
| Example 6 | 30 | 56% | Shower 1 | 120 seconds | 76 g (water: | 51° C. | 41° C. |
| | seconds | | second | | 45 g) | | |
| Comparative | 50 | 65% | Normal | 150 seconds | Nothing | 23° C. | 23° C. |
| Example 1 | seconds | | water cooling | | | | |
| Comparative | 50 | 65% | Shower 1 | 90 seconds | Nothing | 61° C. | 58° C. |
| Example 2 | seconds | | second | | | | |
| Comparative | 50 | 65% | Dipping 1 | 90 seconds | Nothing | 48° C. | 46° C. |
| Example 3 | seconds | | second | | | | |
| Comparative | 50 | 65% | Shower 7 | 90 seconds | Nothing | 33° C. | 32° C. |
| Example 4 | seconds | | seconds | | | | |

TABLE 2

| Test | | | Noodle | Moisture | |
|---|---|---|---|---|---|
| section | Flavor | Texture | weight (g) | content | Comment |
| Example 1 | 3 | 3.5 | 188 | 66% | The flavor is felt like that of Chinese noodles clearly |
| | | | | | as compared with Comparative Example 1 or |
| | | | | | Comparative Example 2, and the flavor is generally |
| | | | | | fair. |
| | | | | | The noodles remain slightly hard on the surface, but |
| | | | | | the texture is also better than Comparative Example |
| | | | | | 1 or Comparative Example 2, and is generally fair or |
| | | | | | better. |
| Example 2 | 5 | 5 | 187 | 66% | As compared with Example 1, the noodles have a |
| | | | | | strong flavor, have texture like boiled noodles |
| | | | | | having soft surfaces and elastic cores, and are very |
| | | | | | good. |
| Example 3 | 4 | 4 | 191 | 66% | The flavor and texture are good, but are a little |
| | | | | | inferior to those of Example 2. |
| Example 4 | 3 | 3.5 | 193 | 67% | The flavor and texture are a little inferior to those |
| | | | | | of Example 3, but are generally fair or better. |
| Example 5 | 5 | 5 | 188 | 66% | A little better flavor is felt than that of Example 2 |
| Example 6 | 4 | 4 | 186 | 66% | The flavor and texture are good, but are a little |
| | | | | | inferior to those of Example 2. |
| Comparative | 1 | 2 | 195 | 67% | The noodles are normal frozen Chinese noodles. |
| Example 1 | | | | | The flavor is weak, and the texture is unbalanced |
| | | | | | texture such that the surfaces are hard, and the cores |
| | | | | | are soft. |
| Comparative | 2 | 3 | 187 | 66% | Steam before freezing comes off. |
| Example 2 | | | | | The texture is generally fair, but the flavor is |
| | | | | | inferior. |
| Comparative | 2 | 2 | 190 | 66% | The flavor and texture are both inferior |
| Example 3 | | | | | |
| Comparative | 1 | 2 | 193 | 67% | The flavor is considerably inferior, and the texture is |
| Example 4 | | | | | also inferior. |

As shown in Comparative Example 1, the temperature of the boiled noodles at the time of the filling and the temperature of the boiled noodles before the freezing treatment are suppressed, and the burden of the freezer is considerably suppressed in the conventional Chinese noodles subjected to water wash cooling. However, the flavor of the noodles after the cooking was markedly weak, and the texture and the smoothness were also weak. The texture was an unbalanced texture such that the surfaces were hard, and the cores were soft.

As shown in Comparative Examples 2 to 4, as the temperature of the boiled noodles was lowered, the flavor became weaker, with respect to the texture, the smoothness became weaker, and the texture became a softer texture as a whole in the case where the sprinkled amount or the water application method was changed than the method in Patent Literature 3 to reduce the burden of the freezer.

As shown in Examples 1 to 4, the boiling time was meanwhile shortened, water was applied, the noodles were able to be then filled with the ice lump containing water into the freezing container and subjected to the freezing treatment with the freezer to further lower the temperature of the noodles before the freezing treatment as compared with Comparative Examples 2 to 4.

Since moisture in an amount by which the moisture of the noodles that became insufficient for eating the noodles due to the shortening of the boiling time was added to the ice lump, the moisture in the ice lump was absorbed into the noodles while boiling at the time of the microwave oven cooking to improve a flavor like the flavor of boiled noodles and make the texture similar to a texture such that the surfaces were soft, and the cores were elastic.

As shown in Examples 1 and 2, the burden of the freezer was not only able to be reduced, but the flavor and texture after the cooking were also improved with the shortening of the boiling time and an increase in the amount of water in the ice lump. However, the data are not shown, but it is believed that since the gelatinization of the surfaces of the noodle does not proceed, excessively shortening the boiling time melts the surfaces of the noodles in the water application step, or leads to a slimy feeling on the surfaces of the noodles in the same way as at the time of the microwave oven cooking, and the noodles therefore need to be gelatinized by boiling cooking to some extent.

As shown in Examples 2 to 4, observed was a tendency such that as the temperature of the boiled noodles was lowered in the water application step, the components on the surfaces of the noodles were not only washed away, but the content of moisture applied to (absorbed into) the noodles also became higher, the flavor was more hardly recovered even in the subsequent microwave oven cooking, and the texture was also softened. It is therefore believed that the temperature of the boiled noodles at the time of filling the freezing container is preferably in the range of 30 to 60° C.

As shown in Examples 2, 5, and 6, observed was a tendency such that as the time from the end of the boiling treatment to the start of the freezing treatment became longer, the flavor and texture of the noodles were deteriorated. It is therefore believed that the time from the end of the boiling treatment to the start of the freezing treatment is preferably 120 seconds or less. As the time is shortened, the temperature of the boiled noodles before the freezing treatment is raised. It is therefore believed that the time from the end of the boiling treatment to the start of the freezing treatment is preferably 60 seconds or more from the viewpoint of lowering the temperature of the boiled noodles before the freezing. It is however believed that if the temperature of the boiled noodles at the time of the filling the freezing container is fully lowered (45° C. or less), the freezing treatment is preferably started even within less than 60 seconds as soon as possible.

### REFERENCE SIGNS LIST

1: freezing container
2: ice lump
3: boiled noodles
4: frozen noodles
51: thermometer (front side)
52: thermometer (center)
53: thermometer (underside)

1. A method for manufacturing frozen noodles, comprising:
a step of subjecting raw noodles or dried noodles manufactured by an ordinary method to boiling treatment to produce boiled noodles containing moisture less than moisture of the noodles after cooking;
a step of applying water to surfaces of the boiled noodles by sprinkling or dipping;
a step of filling a freezing container with the boiled noodles having water applied to the surfaces and an ice lump containing frozen water; and
a step of subjecting the boiled noodles to freezing treatment,
wherein the freezing treatment is started within 120 seconds from an end of the boiling treatment.

2. The method for manufacturing frozen noodles according to claim 1, wherein a temperature of the boiled noodles on filling the freezing container therewith is 30 to 60° C.

3. The method for manufacturing frozen noodles according to claim 1, wherein a weight of the ice lump is 10 to 50% by weight of a total weight of the frozen noodles.

4. The method for manufacturing frozen noodles according to claim 1, wherein an amount of water contained in the ice lump is 5 to 40% by weight of a weight of the noodles after cooking of the frozen noodles.

5. The method for manufacturing frozen noodles according to claim 1, wherein the frozen noodles are Chinese noodles.

6. The method for manufacturing frozen noodles according to claim 1, wherein the frozen noodles are for microwave oven cooking.

7. The method for manufacturing frozen noodles according to claim 2, wherein a weight of the ice lump is 10 to 50% by weight of a total weight of the frozen noodles.

8. The method for manufacturing frozen noodles according to claim 2, wherein an amount of water contained in the ice lump is 5 to 40% by weight of a weight of noodles after cooking of the frozen noodles.

9. The method for manufacturing frozen noodles according to claim 2, wherein the frozen noodles are Chinese noodles.

10. The method for manufacturing frozen noodles according to claim 2, wherein the frozen noodles are for microwave oven cooking.
